(19) United States
(12) Patent Application Publication
(10) Pub. No.: US 2014/0033122 A1
(43) Pub. Date: Jan. 30, 2014

(54) SMART MODULE MANAGEMENT SELECTION

(71) Applicants: Jon Lorenz, San Francisco, CA (US); Gever Tulley, Montara, CA (US)

(72) Inventors: Jon Lorenz, San Francisco, CA (US); Gever Tulley, Montara, CA (US)

(73) Assignee: Adobe Systems Incorporated, San Jose, CA (US)

(21) Appl. No.: 12/271,856

(22) Filed: Nov. 15, 2008

(51) Int. Cl. G06F 3/048

(52) U.S. Cl. 715/810

(57) ABSTRACT

In some example embodiments, a system and method is shown that includes receiving selection input to select content to be presented by a device. A presentation option is selected for a presentation of the content based upon a content type of the content and a presentation attribute.

### COPYRIGHT

A portion of the disclosure of this document includes material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document: Copyright© 2008, Adobe Systems Incorporated. All Rights Reserved.

### TECHNICAL FIELD

The present application relates generally to the technical field of algorithms and programming and, in one specific example, Graphical User Interfaces (e.g., GUIs).

### BACKGROUND

A software application may be composed of various components having associated functionality. These components have well defined interfaces used for communication across components. These components may be introduced as a patch to resolve problems with components that are already utilized by the software application. Further, these components may be used to update the functionality of the software application.

### BRIEF DESCRIPTION OF THE DRAWINGS

Some embodiments are illustrated by way of example and not limitation in the figures of the accompanying drawings in which:

FIG. 1 is a diagram of a system, according to an example embodiment, illustrating the intersection between devices and a context.

FIG. 2 is a diagram of a system, according to an example embodiment, used to retrieve an environment for use in participating in a context.

FIG. 3 is a diagram of a Personal Digital Assistant (PDA), according to an example embodiment, illustrating the presenting of an asset in a display area.

FIG. 4 is a diagram of a PDA, according to an example embodiment, illustrating functionality utilized to resolve a mismatch between applications used on devices within a session.

FIG. 5 is a block diagram of a PDA, according to an example embodiment, illustrating functionality associated with context, environment and session establishment.

FIG. 6 is a block diagram of a computer system, according to an example embodiment, used to contextually manage an application for a device.

FIG. 7 is a block diagram of a computer system, according to an example embodiment, used to contextually manage a device to provide additional functionality to that device to resolve a mismatch.

FIG. 8 is a flow chart illustrating a method, according to an example embodiment, used to contextual manage an application for a device.

FIG. 9 is a flow chart illustrating a method, according to an example embodiment, used to contextually manage a device to provide additional functionality to that device to resolve a mismatch.

FIG. 10 is a dual-stream flow chart illustrating a method, according to an example embodiment, used to request and receive an environment, and to generate an environment update.

FIG. 11 is a dual-stream flow chart illustrating a method, according to an example embodiment, used for the establishment of a content sharing session.

FIG. 12 is a dual-stream flow chart illustrating a method, according to an example embodiment, used to facilitate content streaming as part of a content sharing session.

FIG. 13 is a flowchart illustrating a method, according to an example embodiment, used to resolve a mismatch between the functionality of devices participating in an asset sharing session.

FIG. 14 is a flowchart illustrating the execution of an operation, according to an example embodiment, to identify applications residing on devices that are part of an asset sharing session.

FIG. 15 is a flowchart illustrating the execution of an operation, according to an example embodiment, to retrieve additional session device information for devices participating in an asset sharing session.

FIG. 16 is a dual-stream flowchart illustrating the execution of operation, according to an example embodiment, to use current context information for a particular device to resolve a mismatch.

FIG. 17 is a flowchart illustrating the execution of an operation, according to an example embodiment, that determines an application to process a particular asset based upon common device settings.

FIG. 18 is a flowchart illustrating the execution of operation, according to an example embodiment, that determines an application to process a particular asset based upon the resolution of a mismatch.

FIG. 19 is a Relational Data Schema (RDS), according to an example embodiment.

FIG. 20 shows a diagrammatic representation of a machine in the form of a computer system, according to an example embodiment, that executes a set of instructions to perform any one or more of the methodologies discussed herein.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter. Some portions of the detailed description which follow are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

In some example embodiments, a system and method is shown for managing the selection of software modules utilized to share an asset amongst devices in a network setting. These assets may be shared for viewing, playing, listening, or execution (collectively referenced as a presentation option). An asset includes content or a software application or module (e.g., functionality). Managing may take the form of logic implemented to facilitate the selection of the software module. This logic may use weighted values to select the software module based upon available applications, device information considerations, and/or context information. A software module is an element of a software architecture offering a predefined functionality such as a service or an event, and able to communicate with other modules. The sharing of the asset may be facilitate through the devices operating in a network setting, where the devices are operatively coupled. Operatively coupled includes a physical or logical connection. In some example embodiments, these devices may be part of the same session, context, and/or environment.

In some example embodiments, the selection of a software module occurs where a mismatch between exists between the respective functionalities of software modules existing on two or more operatively connected devices. For example, a mismatch may occur where a device has less of an ability to play a piece of digital content relative to another device, where both devices are part of the same session. Less of an ability includes less functionality. Where such a mismatch occurs, additional software modules are selected to resolve the mismatch. A resolution of a mismatch includes a device in the session retrieving a software module or reconfiguring an existing software module to allow for both devices in the session to have parity in there respective abilities to process an asset. Process includes sharing the asset for viewing, playing, listening, or execution. In some example embodiments, a mismatch is resolved in favor of the most common functionality amongst devices participating in an asset sharing session or session.

In some example embodiments, the resolution of a mismatch is automatically performed by devices participating in an asset sharing session. For example, assume two devices are participating in an asset sharing session to view in an asset in the form of an image slide show. The first device can only display the slide show one image at a time, while the second device can display all images in the slide show at once in a display area. To resolve the mismatch between the first device and the second device, the first device may execute logic to select or retrieve an additional software module to augment it existing functionality such that all images of the image slide show may be displayed at once in a display area. Where both devices participating in the session can display all the images of the image slide show at once, parity between the devices is attained and the mismatch resolved. A slide show is just one example case. Other cases include resolving a mismatch between algorithms used to display content on a device display, resolving a mismatch between functionality used to edit content, or some other type of mismatch between functionality associated with devices that once resolved will allow two or more devices to process content.

In some example embodiments, the resolution of a mismatch between devices through the selection of additional software modules can be applied in other contexts as: well. For example, where there is a mismatch in the speed with which one device may process graphical images as compared to another device, a software module may be retrieved to resolve this mismatch. Additionally, where there is a mismatch in the ability of a device to stream data based upon the use of a particular codec as compared to another device, the device may retrieve a software module that allows for the device to stream data using the codec.

### Example System

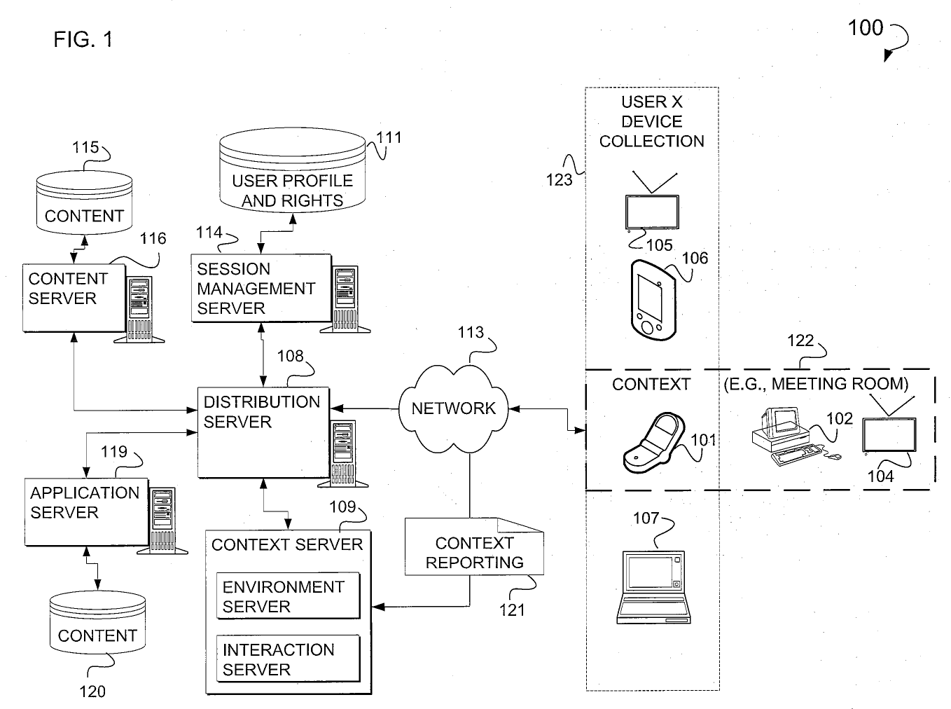

FIG. 1 is a diagram of an example system 100 illustrating the intersection between devices and a context. Shown is a device collection, referenced herein at 123, that includes a number of devices (e.g., computing platforms). These devices utilized by a user include, for example, a television 105, PDA 106, cell phone 101, and laptop computer (e.g., “laptop”) 107. In some example embodiments, one or more of these devices may participate in a context, referenced herein at 122, with other devices. These other devices include a computer 102 and a television 104. Within the context 122, the cell phone 101, computer 102, and television 104 may share an asset. One or more of the various devices in the context 122 may engage in context reporting through the generation of a context report 121. The context report 121 includes information relating to the devices and users participating in a context. The context report 121 is transmitted across the network 113 and is received by, for example, the distribution server 108. The context report 121 may be formatted using an eXtensible Markup Language (XML). The network 113 may be an Internet, a Local Area Network (LAN), a Wide Area Network (WAN), or some other suitable type of network as associated topology.

In some example embodiments, operatively connected to the network 113, is the previously referenced distribution server 108. Operatively connected includes a physical or logical connection. Operatively connected to the distribution server 108 may be a session management server 114, a context server 109, a content server 116, and an application server 119. These various servers (e.g., 108, 114, 109, and 116) may participate in a cloud computing paradigm. Additionally, these various servers may be implemented on a single computer system, or multiple computer systems. In some example embodiments, the distribution server is used to manage data flowing from the context 122, and to route this data. The context server 109 includes an environment server and an interaction server. The interaction server tracks the interactions between devices in the context 122. Interactions include the sharing of assets between devices in the context 122. The environment server tracks the environment within which the interaction occurs. The environment includes data relating to the interaction such as the physical location of the devices participating in the context, the time and date of participation by the devices within the context 122, the amount and type of assets shared and other suitable information. The session management server 114 is used to establish and manage an asset sharing session. A session is an environment that is uniquely identified via a unique numeric identifier (e.g., a session ID) so as to regulate participants in the session. Participants may use a session identifier in combination with a user ID and/or device ID to facilitate their participation in a session. Operatively connected to the session management server 114 is a user profile and rights data store 111 that includes the session ID, the user ID, and/or device ID. Rights include legal rights associated with an asset and its use. Additionally, illustrated is a content server 116 that serves an asset in the form of content to context participants. Content includes, for example, images, animations, video, audio, audio-video, or text-based content. This content is stored in the content data base 115 that is operatively connected to the content server 116. Additionally, an application server 119 is shown that is used to serve applications to context participants. Applications include executables, code modules, software components, and software applications. These applications are stored in the content database 120. These applications may be used to enhance, augment, supplement, or facilitate the functionality of one or more of the devices participating in the context 122.

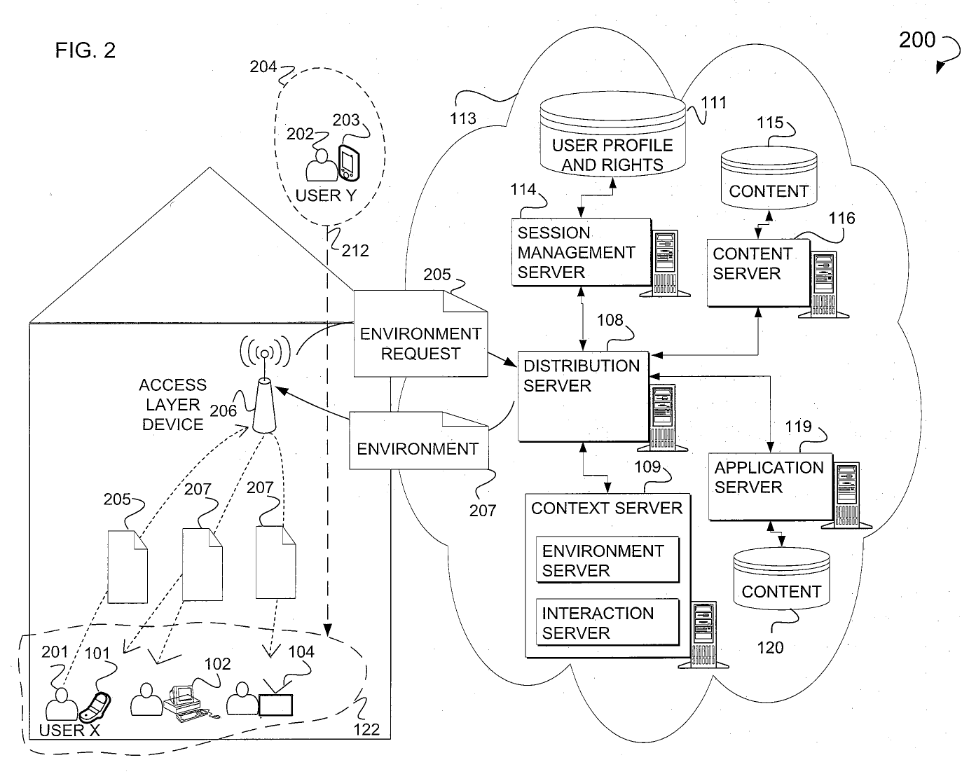

FIG. 2 is a diagram of an example system 200 used to retrieve an environment for use in participating in a context. Shown is a user 201, referenced as “user x,” that is associated with the cell phone 101. This user 201 is also associated with the device collection 123. Further, shown is the computer 102 and television 104. As previously illustrated in FIG. 1, the cell phone 101, computer 102, and television 104 all participate in the context 122. This context 122 may be in the form of a meeting occurring in a physical structure. In some example embodiments, the user 201 generates an environment request 205 that is received by an access layer device 206. This access layer device 206 transmits this environment request 205 across the network 113. The environment request 205 may include information relating to the relative physical location context participants, where information pertaining to this relative location is requested via the environment request 205. The distribution server 108, or one of the other servers (e.g., 108, 114, 109, 119, and 116), may transmit an environment 207. This environment 207 may be distributed by the access layer device 206 to one or more of the context participants (e.g., the cell phone 101, computer 102, or television 104). Additionally, illustrated is a user 202, referenced as a “user y.” This user 202 may have their own context 204 in which the PDA 203 participates. In some example embodiments, the content 204 and context 122 may be combined together to form a single context. This combination of contexts may occur where the PDA 203 joins the context 122.

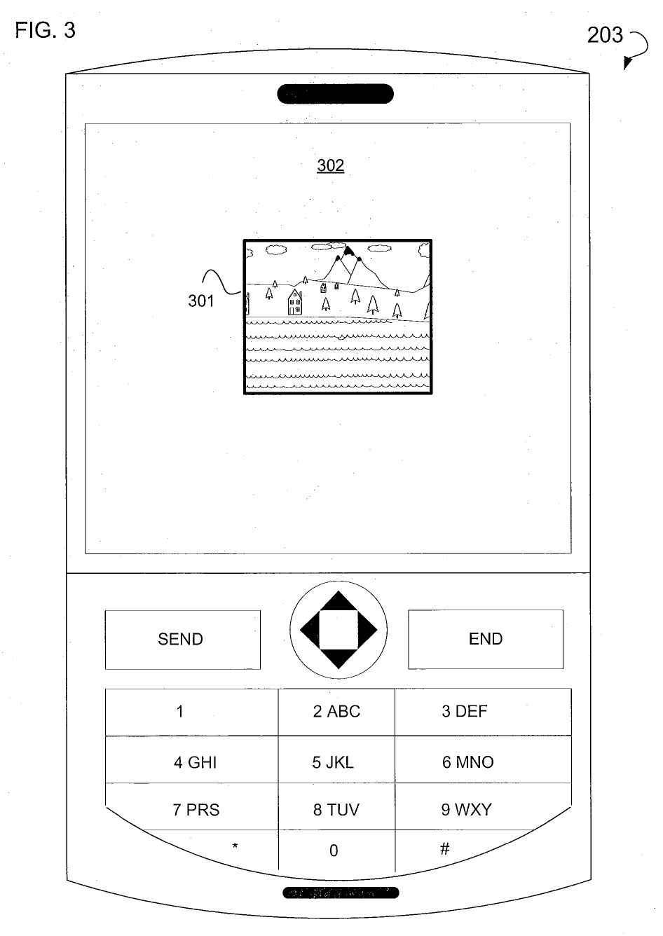

FIG. 3 is a diagram of an example PDA 203 illustrating the display of an asset in a display area operatively coupled to the PDA 203. Shown is an asset in the form of an image 301. This image 301 is displayed within the display area 302 operatively coupled to the PDA 203. In some example embodiments, when the PDA 203 is a participant in a session with the devices 101, 102 or 104, the PDA 203 shares an asset in the form of the image 301 with one or more of these devices. Specifically, the context, environment, or session may dictate that the image 301 be shared. To facilitate this sharing, a capability mismatches between the PDA 203 and the devices 101, 102, and 104 are determined and resolved. The mismatch may include differences in functionality of applications between the devices and their ability to process (e.g., play, listen, view, or execute) the asset using these applications. In resolving this mismatch, additional functionality for an application may be used to execute a particular asset.

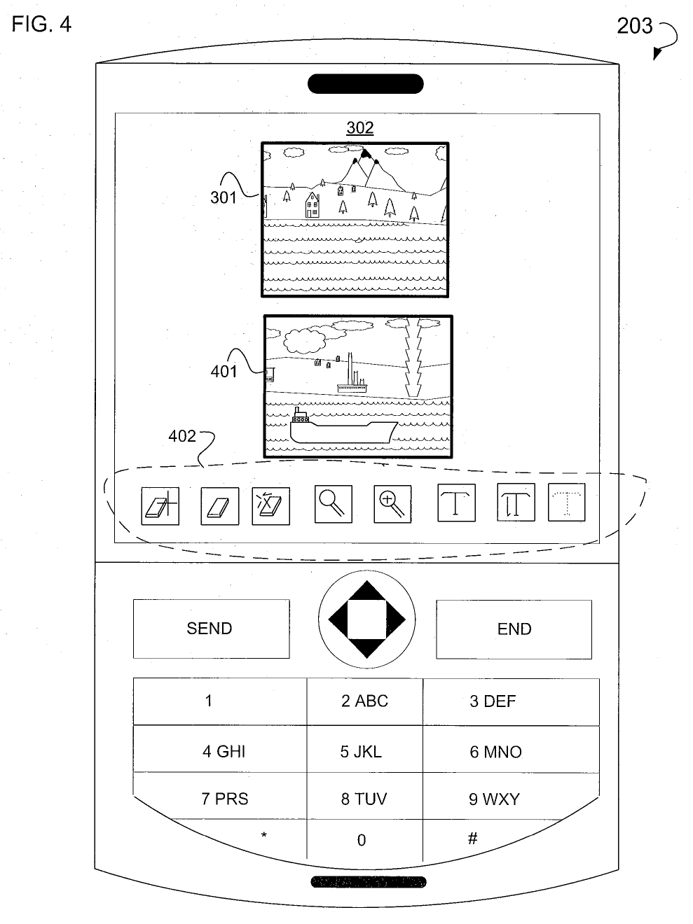

FIG. 4 is a diagram of an example PDA 203 illustrating additional functionality utilized to resolve a mismatch between applications used on a device. In some example embodiments, the PDA 203 participates in a session with the devices 101, 102 and 104. A mismatch may be found to exist between the PDA 203 and one or more of these devices, wherein this mismatch is between an application residing on the PDA 203 and one or more applications residing on the devices 101, 102 and 104. In cases where a mismatch occurs, additional functionality may be enabled to allow for an asset in the form of the image 301 and 401 to be displayed within the display area 302 within PDA 203. Moreover, additional functionality (e.g., screen widgets representing additional functionality) are provided that allows for, for example, the images 301 and 401 to be edited, as reflected at 402. The editing of these images 301 and 304 is facilitated to provide additional functionality to the PDA 203, where this functionality already exist with the device 101, 102 or 104.

### Example Logic

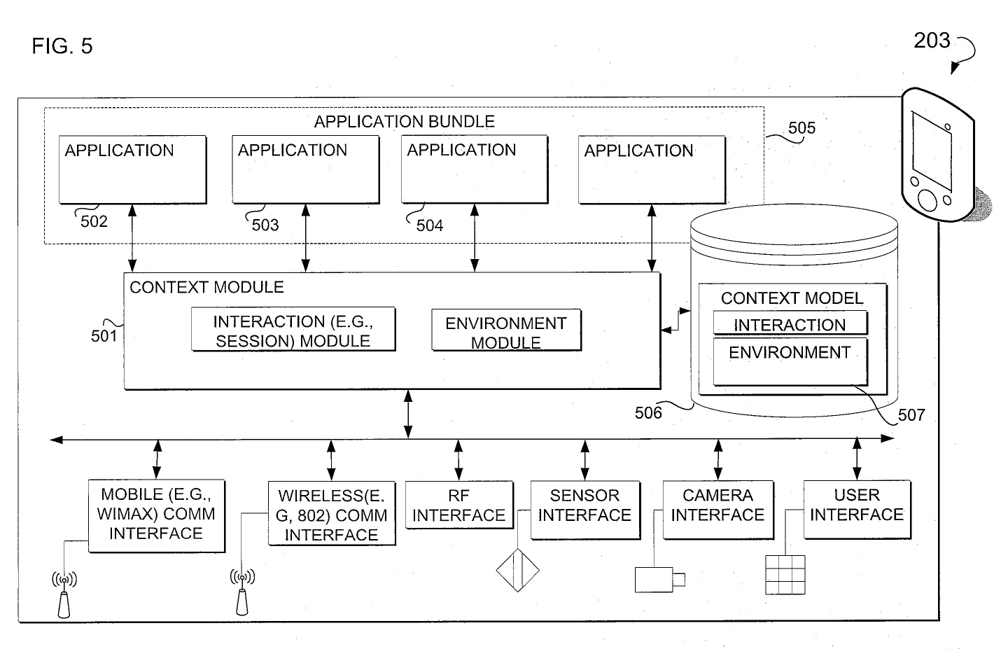

FIG. 5 is a block diagram of an example PDA 203 that includes functionality that enables the PDA 203 to interact with other devices in a context, environment, or session. The various blocks illustrated herein may be implemented by a computer system as hardware, firmware, or software. Additionally, these blocks may be processor-implemented blocks in the form or modules or components. Shown is a context module 501 that includes an interaction module. This interaction module may be used to establish a session in which devices may participate. Additionally, the context module may include an environment module that is used to generate the environment request 205, and to process the environment 207. Operatively connected to the context module 501 is an application bundle 505 (e.g., a suite of applications). Included in this application bundle 505 are applications 502 through 504. These applications may be used to present assets including content and applications. Present includes, for example, display, play, record, and execute. Example applications include FLASH® of Adobe Systems, Inc., ACROBAT® of Adobe Systems, Inc., PHOTOSHOP® of Adobe Systems, Inc., or some other suitable application. Additionally, operatively connected to the context module 501 is a data store 506 that includes environment data 507 as part of a context model. Included as part of this context model may be session information including a session ID, user ID, and/or device ID. Additionally, included as part of this environment data 507 is the environment 207.

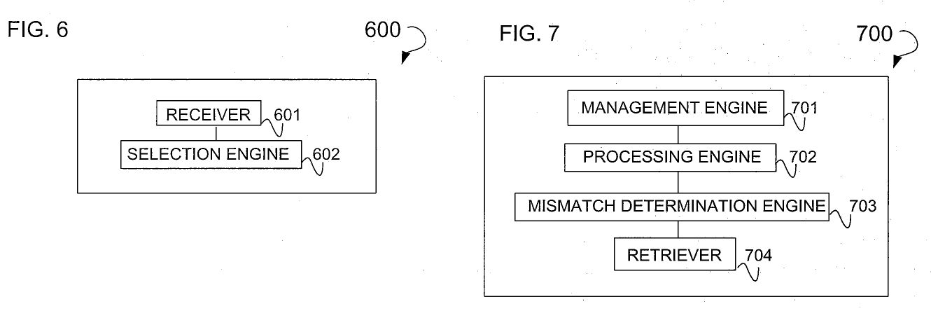

FIG. 6 is a block diagram of an example computer system 600 used to contextual manage an application for a device. The blocks shown herein may be implemented in software, firmware, or hardware. Additionally, these blocks may be processor-implemented blocks in the form or modules or components. These blocks may be directly or indirectly communicatively coupled via a physical or logical connection. The computer system 600 may be the PDA 203 shown in FIG. 2. Shown are blocks 601 through 602. Illustrated is a receiver 601 to receive selection input to select content to be presented by a device. Communicatively coupled to the receiver 601 is a selection engine 602 to select at least a first presentation option from a plurality of presentation options for a presentation of the content, the selecting of the at least the first presentation option being based upon both a content type of the select content and a presentation attribute. In some example embodiments, the presentation attribute is an attribute of the selection input. In some example embodiments, the attribute of the selection input comprises a number of content items of the content to be presented by the device. Further, the content type of the content may be image content, and the first presentation option is a view option that is selected based on a single image being selected. Additionally, the content type of the content may be image content, and the first presentation option is a multi-item presentation option that is selected based on multiple images being selected. Moreover, the multi-item presentation option may be a slideshow presentation option. In addition, the multi-item presentation option is secondary selection option. The presentation attribute may be a context attribute of a context within which the content is to be presented by the device. The context attribute may be an environment attribute relating to an environment within which the content is to be presented by the device. In some example embodiments, the environmental attribute identifies a number of users to which the content is to be presented by the device. Further, the context attribute is an interaction attribute relating to an interaction within which the content is to be presented by the device. In some example embodiments, the interaction is a network-based session within which the presentation of the content is shared among a plurality of devices. The selection of the first presentation option may comprise selection of a first application from among a plurality of applications for the presentation of the content. The selection of the first presentation option may comprise a selection of a first presentation mode from among a plurality of presentation modes of a presentation application. The presentation attribute may be an attribute of the device on which the content is to be presented.

FIG. 7 is a block diagram of an example computer system 700 used to contextually manage a device to provide additional functionality to that device to resolve a mismatch. The blocks shown herein may be implemented in software, firmware, or hardware. Additionally, these blocks may be processor-implemented blocks in the form or modules or components. These blocks may be directly or indirectly communicatively coupled via a physical or logical connection. The computer system 700 may be the PDA 203, distribution server 108, application server 119 or some other suitable device shown in FIG. 2. Shown are blocks 701 through 704. Illustrated is a management engine 701 to contextually manage a first content application to determine additional functionality to be used to process content. Communicatively coupled to the management engine 701 is a processing engine 702 to process the content using the first content application that utilizes the additional functionality. In some example embodiments, managing the first content application, to determine the additional functionality to be used to process the content, includes a mismatch determination engine 703 communicatively coupled to the processing engine 702. The mismatch determination engine 703 determines a capability mismatch to exist between the first content application residing upon a first device, and a second content application residing upon a second device. The capability mismatch exists where the first content application has less functionality to process the content as compared to functionality associated with the second content application. Communicatively coupled to the mismatch determination engine 703 is a retriever 704 to retrieve additional functionality for the first content application to resolve the capability mismatch.

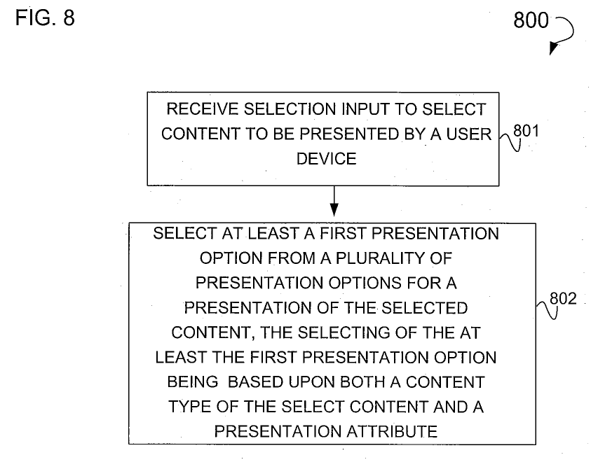

FIG. 8 is a flow chart illustrating an example method 800 used to contextually manage an application for a device. Shown are various operations 801 through 805 that may be executed on the PDA 203 shown in FIG. 2. An operation 801 is shown that is executed by the receiver 601 to receive selection input to select content to be presented by a device. Operation 802 is shown that is executed by the selection engine 602 to select at least a first presentation option from a plurality of presentation options for a presentation of the content, the selecting of the at least the first presentation option being based upon both a content type of the select content and a presentation attribute. The presentation attribute may be an attribute of the selection input. The attribute of the selection input comprises a number of content items of the content to be presented by the device. Further, the content type of the content may be image content, and the first presentation option is a view option that is selected based on a single image being selected. Additionally, the content type of the content may be image content, and the first presentation option is a multi-item presentation option that is selected based on multiple images being selected. Moreover, the multi-item item presentation option may be a slideshow presentation option. In addition, the multi-item presentation option is secondary selection option. The presentation attribute may be a context attribute of a context within which the content is to be presented by the device. A presentation attribute may be a display area, a screen, or a GUI. The context attribute may be an environment attribute relating to an environment within which the content is to be presented by the device. In some example embodiments, the environmental attribute identifies a number of users to which the content is to be presented by the device. Further, the context attribute is an interaction attribute relating to an interaction within which the content is to be presented by the device. The interaction may be a network-based session within which the presentation of the content is shared among a plurality of devices. The selection of the first presentation option may comprise a selection of a first application from among a plurality of applications for the presentation of the content. The selection of the first presentation option may comprise a selection of a first presentation mode from among a plurality of presentation modes of a presentation application. In some example embodiments, the presentation attribute is an attribute of the device on which the content is to be presented.

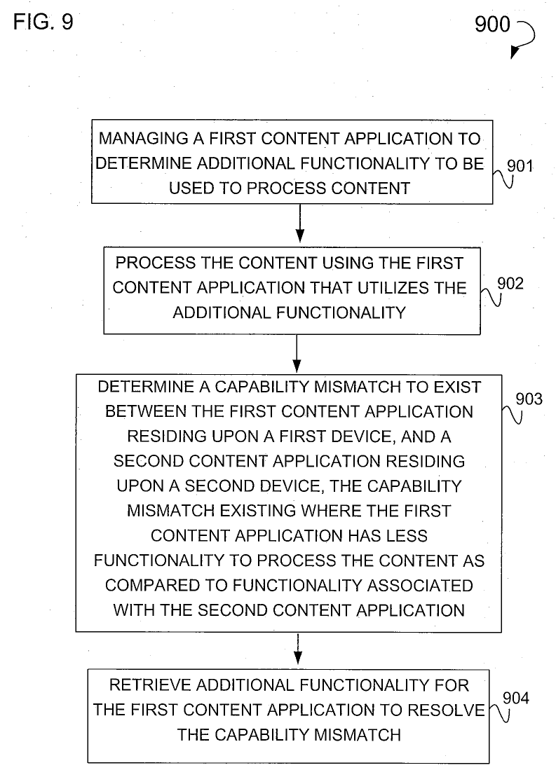

FIG. 9 is a flow chart illustrating an example method 900 used to contextually manage a device to provide additional functionality to that device to resolve a mismatch. Shown are various operations 901 through 904 that may be executed on the distribution server 108, application server 119 or some other suitable device shown in FIG. 1. An operation 901 is shown that is executed by the management engine 701 to contextually manage a first content application to determine additional functionality to be used to process content. An operation 902 is executed by the processing engine 702 to process the content using the first content application that utilizes the additional functionality. In some example embodiments, the contextual management of the first content application, to determine the additional functionality to be used to process the content, includes the execution of a number of operations. These operations include an operation 903 that is executed by the mismatch determination engine 703 to determine a capability mismatch to exist between the first content application residing upon a first device, and a second content application residing upon a second device, the capability mismatch to exist where the first content application has less functionality to process the content as compared to functionality associated with the second content application. An operation 904 is executed by the retriever 704 to retrieve additional functionality for the first content application to resolve the capability mismatch.

In some example embodiments, a computer-implemented method is illustrated. This method may be implemented as instructions on a computing platform so that a selection of content to be presented by a device is received. Additionally, this method may include executing the instructions on the computing platform so that at least a first presentation option from a plurality of presentation options for a presentation of the content is selected, the selecting of the at least the first presentation option being based upon both a content type of the content and a presentation attribute.

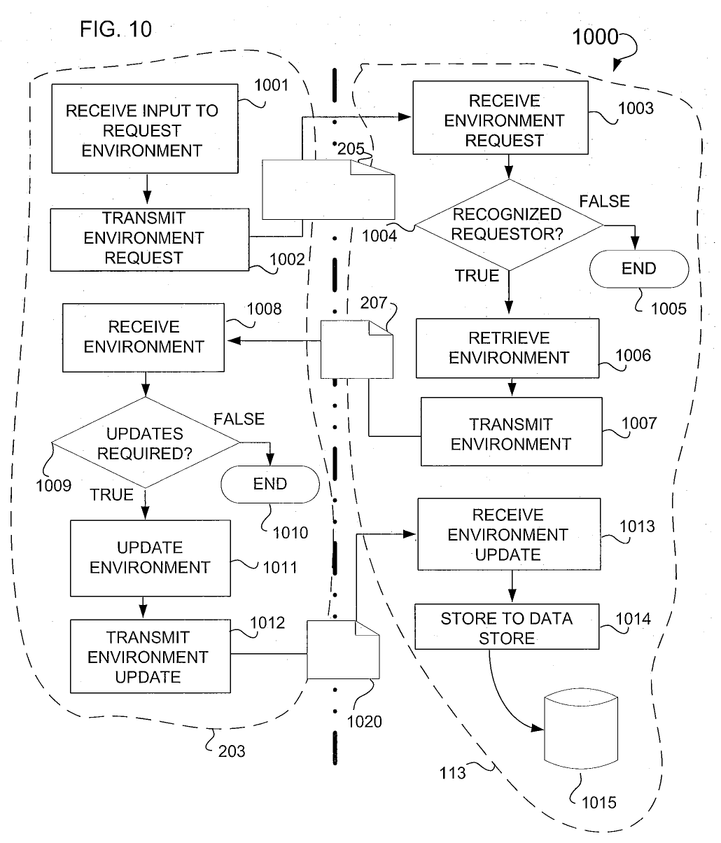

FIG. 10 is a dual-stream flow chart illustrating an example method 1000 used to request and receive an environment, and to generate an environment update. Shown are operations 1001 through 1002, and 1008 through 1012. These various operations may be executed by the PDA 203, or other suitable device that interacts in the context 122. Also shown are operations 1003 through 1007, and 1013 through 1014. These various operations are executed with the network 113 and the various servers (e.g., 108, 114, 109, and 116) illustrated therein. For example, the distribution server 108 may execute these various operations 1003 through 1007, and 1013 through 1014. Shown is an operation 1001 that, when executed, receives input to request an environment. This input may be generated by an input device such as a touch screen, mouse, keyboard, light pen, or other suitable input device. Operation 1002 is executed to transmit the environment request 205. Operation 1003, when executed, receives the environment request 205. Decisional operation 1004 is executed to determine whether the device, and user associated therewith, is recognized as being able to request an environment. Where decisional operation 1004 evaluates to “false,” a termination condition 1005 is executed as the requesting device or user is unrecognized. In case where decisional operation 1004 evaluates to “true,” an operation 1006 is executed. Operation 1006, when executed, retrieves an environment from, for example, the context server 109 and data store associated therewith (not pictured). Operation 1007 is executed to transmit the environment 207. Operation 1008 is executed to receive the environment 207. In some example embodiments, the operation 1008 is executed by one of more of the interfaces shown in FIG. 5. A decisional operation 1009 is executed to determine whether an update of the environment 207 is required. In cases where decisional operation 1009 evaluates to “false,” a termination condition 1001 is executed. In cases where decisional operation 1009 evaluates to “true,” an operation 1011 is executed. Operation 1011 is executed to update the environment 207. This update may include additional location information relating to the cell phone 101, or other device participating in the context 122. Operation 1012 is executed to transmit an environment update 1020. This environment update 1020 is received through the execution of operation 1013. Operation 1014 is executed to store the environment update 1020 into a data store 1015.

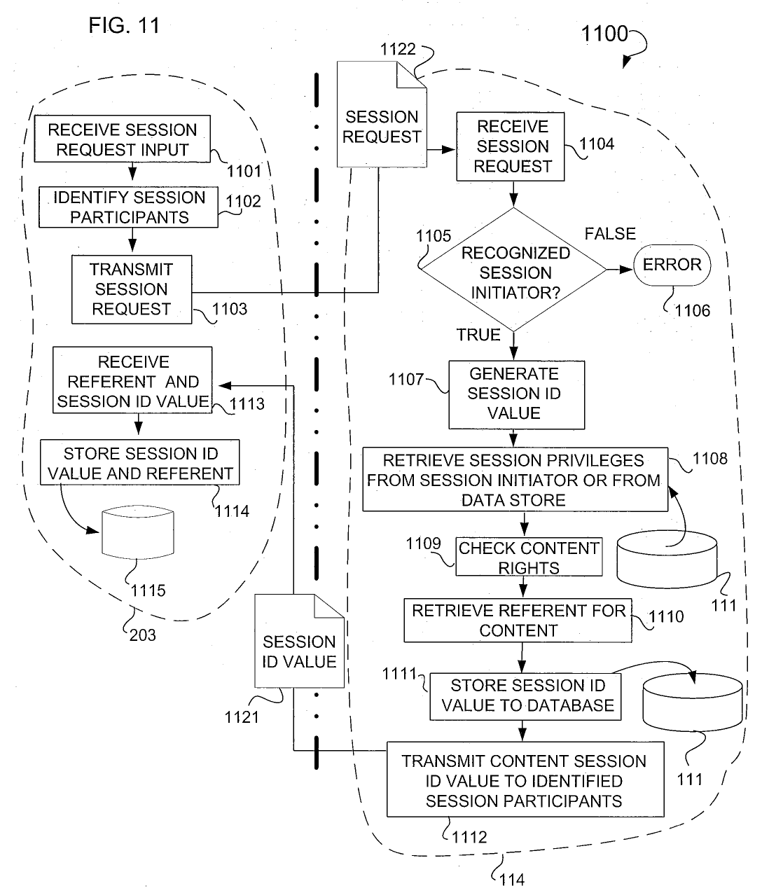

FIG. 11 is a dual-stream flow chart illustrating a method 1100 used for the establishment of a content sharing session. Shown are various operations 1101 through 1103, and 1113 through 1114 that are executed by the PDA 203. Further shown are various operations 1104 through 1112 that are executed by the session management server 114. Illustrated is an operation 1101 that, when executed, receives session request input. This input may be generated through the use of a mouse, light pen, touch screen, keyboard, or other suitable input device. An operation 1102 is executed to identify session participants. These session participants may be the devices 101 through 104, and/or the users associated with these devices 101 through 104. An operation 1103 is executed to transmit the session request 1122 across the network 113. An operation 1104 is executed to receive this session request 1122. A decisional operation 1105 is executed to determine whether the session initiator (e.g., the device or person as identified via a device ID, and/or user ID) may establish a session. In cases where decisional operation 1105 evaluates to “false,” an error condition 1106 is noted. In cases where decisional operation 1105 evaluates to “true,” an operation 1107 is executed that generates a session ID value. Operation 1108 is executed to retrieve session privileges from the session initiator (e.g., the device 101 and/or the associated user), or from the database 111. An operation 1109 is executed that checks for the existence of the content rights associated with the session initiator. Operation 1110 is executed to retrieve a referent for content. This referent, as used herein, may be a pointer, or a Uniform Resource Identifier (URI) such as a Uniform Resource Locator (URL). In some example embodiments, a pointer may be used in combination with a URI. This reference may be retrieved from the content server 116. An operation 1111 is executed to store the session ID value to the database 111. An operation 1112 is executed to transmit the content session ID value to the identified session participants and/or the session initiator. This session ID value 1121 is received through the execution of operation 1113. The session ID value 1121 may further include the retrieved referent to the content (see e.g., operation 1110). Operation 1114 is executed to store the session ID value and referent into a data store 1115 that may reside natively or non-natively on the PDA 203.

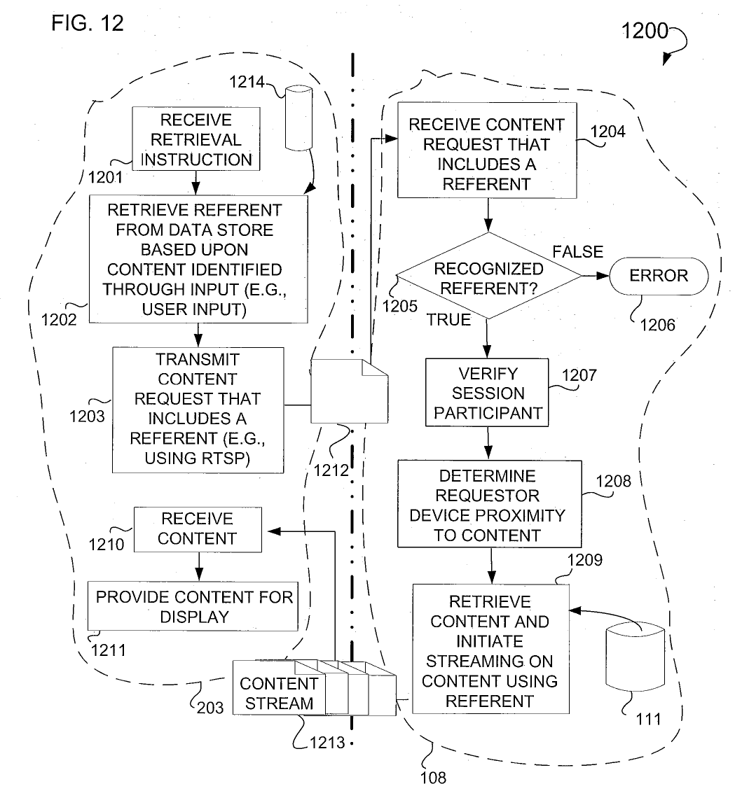

FIG. 12 is a dual-stream flow chart illustrating a method 1200 used to facilitate content streaming as part of a content sharing session. Shown are operations 1201 through 1203, and 1210 through 1211 that reside upon or that are otherwise are executed by the PDA 203. Further, shown are operations 1204 through 1209 that are executed by or otherwise reside upon the distribution server 108. Shown is an operation 1201 that is executed to retrieve retrieval instructions. These retrieval instructions may be automatically retrieved by the PDA 203, or made may retrieved as the result of user input. Further, an operation 1202 is executed to retrieve a referent from a data store 1214 based upon certain identified content. An operation 1203 is executed to transmit a content request that includes the referent. This content request may be the content request 1212. Operation 1204, when executed, receives the content request 1212. Decisional operation 1205 is executed to determine whether or not the referent is recognized. A recognized referent is one that has been allocated by the server management server 114, application server 119, or content server 116 for the purposes of accessing content. In cases where decisional operation 1205 evaluates to “false,” an error condition is noted. In cases where decisional operation 1205 evaluates to “true,” an operation 1207 is executed. Operation 1207, when executed, verifies the session participant (e.g., the PDA 203 and/or the user associated with the PDA 203). Operation 1208 is executed to determine the requestor's device proximity to the content. Specifically, operation 1208 determines the proximity of, for example, the PDA 203 to the location of the content to be streamed to the PDA 203. Operation 1209 is executed to retrieve content from the database 115, and to initiate streaming. Operation 1210 is executed to receive the content stream 1213. Operation 1211 is executed that provides the content for, for example, display on the PDA 203. In some example embodiments, the content stream 1213 is stored into the data store 1815 for future viewing or use. In some example embodiments, a software component is provided in lieu of the content stream 1213 such that a software component is retrieved through the execution of operation 1209 and transmitted to the PDA 203. This software component may be stored into the data store 1214 for current or future use.

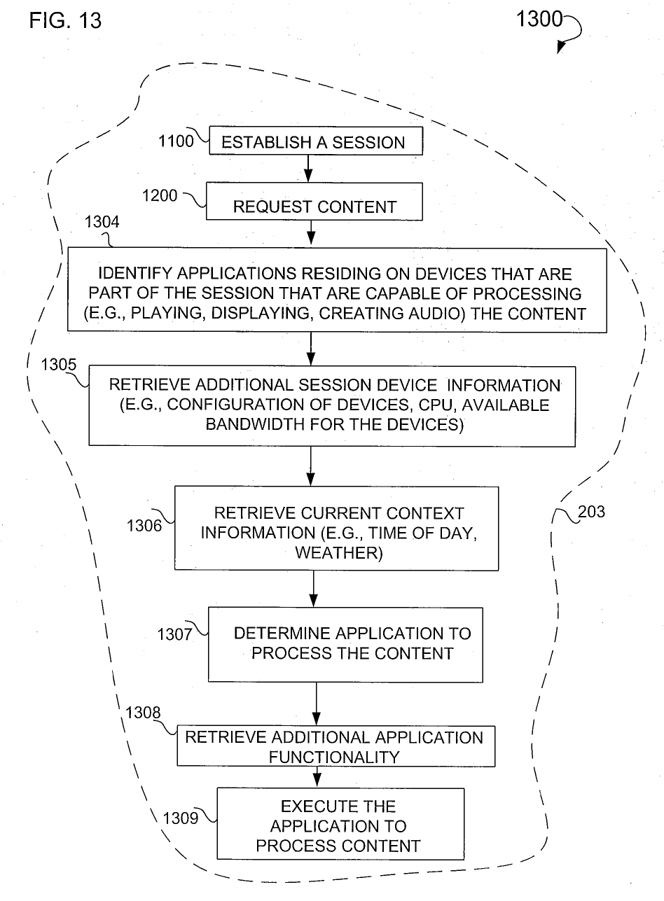

FIG. 13 is a flowchart illustrating an example method 1300 used to resolve a mismatch between the functionality of devices participating in a session. Shown are methods and operations 900, and 1000, and 1304 through 1309. An operation is sub-procedure of a method. These various operations and methods may be executed by the PDA 203. A method 1100 is shown that is used to establish a session. Further, method 1200 is shown to generate a content request. Operation 1304 is executed to identify applications residing on devices that are part of a session, where these applications are capable of processing a particular asset in the form of content or an application. Operation 1305 is executed to retrieve additional session device information for devices participating in a session. This additional session device information may include device configuration information, Central Processing Unit (CPU) cycle speed information, and/or the available bandwidth for a particular device. Operation 1306 is executed to use current context information for a particular device where this context information may include a time of day, weather, or some other context information (e.g., an environment) associated with a particular device. Operation 1307 is executed that determines an application to process a particular asset. This application may be a media-player application, an Adobe Systems, Inc. FLASH® player application, PHOTOSHOP® application, FLEX® application, a text or word processing application, or some other suitable application. Operation 1308 is executed that reviews additional application functionality and resolves a mismatch between the application functionalities of various devices participating in the session. The resolution of the mismatch may include retrieving additional application functionality to augment the application. Operation 1309 is executed to process the content using, for example, the application with the augmented functionality.

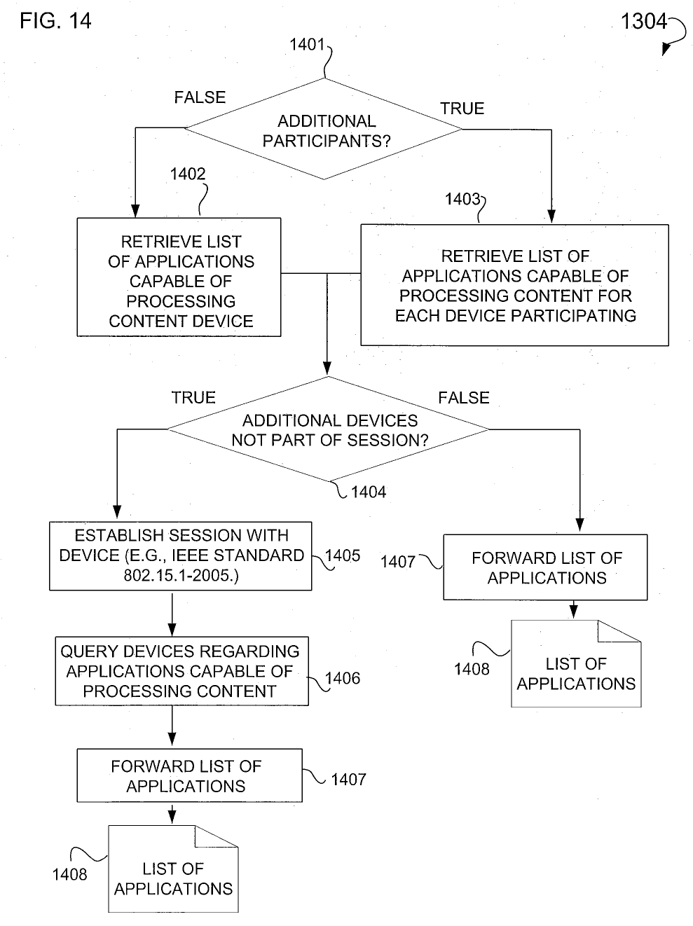

FIG. 14 is a flowchart illustrating the execution of operation 1304. Shown is a decisional operation 1401 that determines the existence of additional participants (e.g., devices). In cases where a decisional operation 1401 evaluates to “false,” an operation 1402 is executed. In cases where decisional operation 1401 evaluates to “true,” an operation 1403 is executed. Operation 1402 is executed to retrieve a list of applications capable of processing a particular asset where there are no additional session participants. Operation 1403, when executed, retrieves a list of applications capable of processing an asset (e.g., content) for each device participating in the session. A decisional operation 1404 is executed to determine whether the additional device is part of the session as opposed to participating in a context or environment. In cases where decisional operation 1404 evaluates to “false,” an operation 1407 is executed. In cases where decisional operation 1404 evaluates to “true,” an operation 1405 is executed. Operation 1407 is executed to forward a list of applications 1408 capable of processing the asset. Operation 1405 is executed to establish the session between devices, where the session may be based upon some type of protocol that is used for communication between devices. Operation 1406 is executed to query the one or more devices participating in the session regarding their capabilities to process a particular asset. Specifically, the functionality of each application may be retrieved (see e.g., table 1906) and a determination made as to the capabilities of the application to process the asset. Some applications may be more or less able to process the content. Operation 1407 is executed to forward a list of applications, where these applications include the previously reference list of applications 1408.

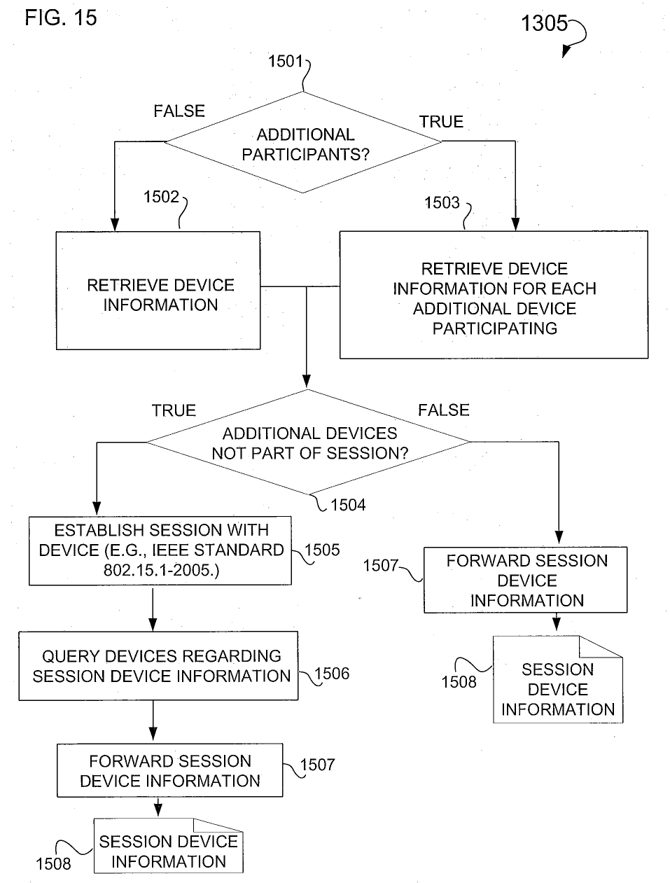

FIG. 15 is a flowchart illustrating the execution of operation 1305. Shown is a decisional operation 1501 that determines whether there are additional participants (e.g., in an environment or content), where these participants include devices, In cases where a decisional operation 1501 evaluates to “true,” an operation 1503 is executed. In cases where a decisional operation 1501 evaluates to “false,” an operation 1502 is executed. Operation 1502 is executed to retrieve device information (e.g., information regarding a particular device, such as configuration or hardware information). Operation 1503 is executed to retrieve device information for each additional participant. A decisional operation 1504 is executed that determines whether there are additional devices that are not part of the session. In cases where decisional operation 1504 evaluates to “false,” an operation 1507 is executed. In cases where a decisional operation 1504 evaluates to “true,” an operation 1505 is executed. Operation 1505 is executed to establish a session with a device where the session may be some type of communication protocol-based session between devices. Operation 1507 is executed to forward session device information in the form of session device information 1508. An operation 1506 is executed to query devices regarding their particular session device information. Operation 1507 is executed so as to general the session device information 1508.

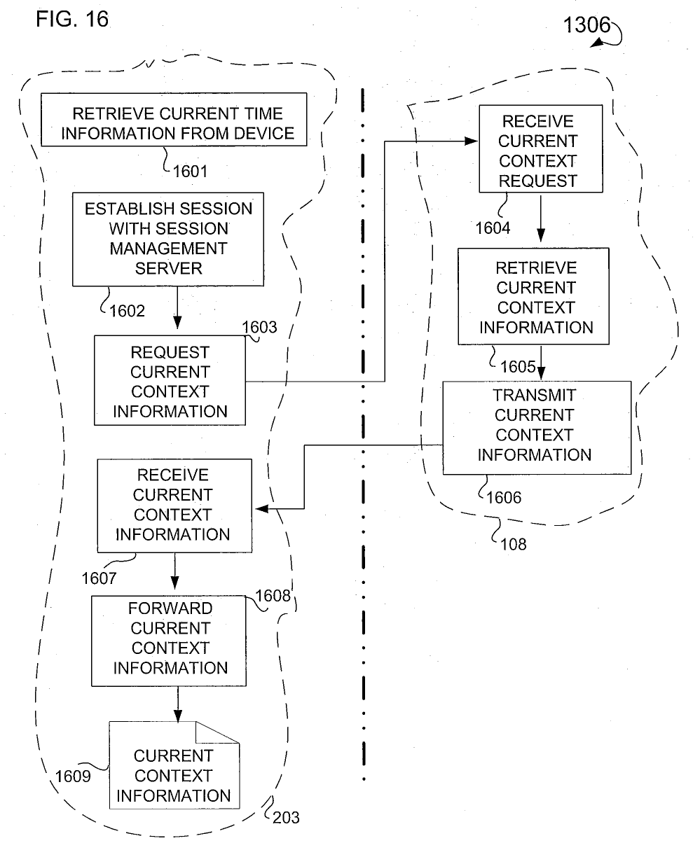

FIG. 16 is a dual-stream flowchart illustrating the execution of operation 1306. Shown are operations 1601 through 1603, and 1607 through 1608. These operations may be executed by the PDA 203. Also shown are operations 1604 through 1606 that may be executed by the distribution server 108. Operation 1601 is executed to retrieve current time information from a device. Operation 1602 is executed to establish a session with the distribution server 108, and/or the session management server 114. This establishment of a session may be based upon or otherwise facilitated through the execution of method 900. Operation 1603 is executed to request current context information from the distribution server 108, context server 109, session management server 114, or other suitable device in FIG. 1. Operation 1604 is executed that receives a current context request. Operation 1605 is executed to retrieve the current context information from the distribution server 108, context server 109, or other suitable device in FIG. 1. Operation 1606 is executed to transmit the current context information that is retrieved from a data store (e.g., table 1705). This current context information is received through the execution of operation 1607. This current context information includes weather information, time of day information, and other information used in determining what application is suitable for use in processing an asset. Operation 1608 is executed to forward this current context information in the form of the current context information 1609. In some example embodiments, the execution of operation 1603 is dependent upon the retrieval of information from the distribution server 108 and/or context server 109. This context information may be in the form of an environment.

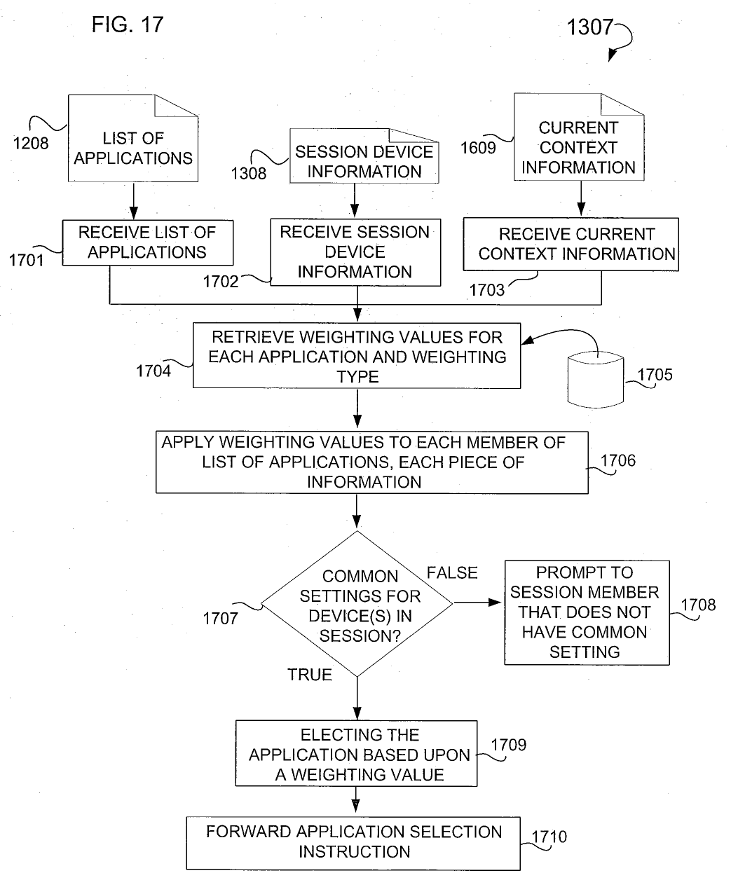

FIG. 17 is a flowchart illustrating the execution of operation 1307. Shown is a list of applications 1208, session device information 1308, and current context information 1609. An operation 1701 is executed to receive the listed applications 1208. Operation 1702 is executed to receive the session device information 1308. Operation 1703 is executed to receive the current context information 1609. Operation 1704 is executed to retrieve weighting values for each application and weighting type. These weighting values are retrieved from the data store 1705. Operation 1706 is executed to apply the weighting values to each member of the list of applications, or each piece of information included in the session device information 1308, and the current context information 1409. These weighting values may be predetermined based upon certain criteria as determined by a system administrator or other individual. These weighting values may give a greater or lesser value, or preference to a particular application included in a list of applications, a particular type of session device information (e.g., CPU cycle speed, memory speed, bandwidth associated with device), or a particular current context information (e.g., the physical location of the device, the time of day, weather). A decisional operation 1707 is executed that determines common settings for a device in a session. These settings may be the most common setting across all devices participating in a session. Settings include preexisting values for session device information, current context information, or application configuration values. In cases where decisional operation 1707 evaluates to “false,” an operation 1708 is executed. Operation 1708 prompts a session participant (e.g., the PDA 203 and/or the devices 101, 102 and 104) that the device does not have a setting in common with the other devices participating in the session. In cases where decisional operation 1707 evaluates to “true,” an operation 1709 is executed. Operation 1709 elects a particular application based upon the weighting values applied to the execution of operation 1706. Operation 1710 is executed that forwards an application selection instruction where this application selection instruction includes a description or reference to the elected application.

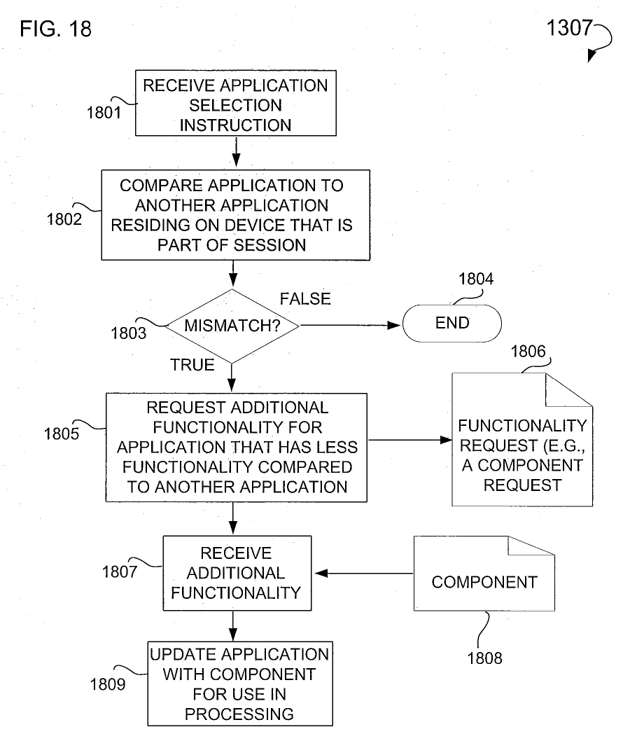

FIG. 18 is a flowchart illustrating the execution of operation 1307. Shown is an operation 1801 that receives an application selection instruction. Operation 1802 is executed that compares the application referenced in the application selection instruction to another application residing on a device as a part of a session. A decisional operation 1803 is executed that determines whether a mismatch exists between an application and another application residing on the device as part of the session. In cases where decisional operation 1803 evaluates to “false,” a termination of condition 1804 is executed. In cases where decisional operation 1803 evaluates to “true,” an operation 1805 is executed that requests additional functionality for an application that has less functionality as compared to another application. This additional functionality is requested to enable a device to process the asset in the form of content or an application. Through the execution of operation 1805, a functionality request 1806 is generated and transmitted. This functionality request may be a request for a particular software component that is transmitted to the distribution server 108. In response, the distribution server 108 retrieves a component 1808 from the application server 119, and transmits it back to the device making the request (e.g., PDA 203). Operation 1807 is executed that is to receive the component 1808. Operation 1809 is executed to update the application with the component for use in processing the asset.

### Example Database

Some embodiments may include the various databases (e.g., 111, 115, 120, 1115, or 1705) being relational databases, or, in some cases, On Line Analytic Processing (OLAP)-based databases. In the case of relational databases, various tables of data are created and data is inserted into and/or selected from these tables using a Structured Query Language (SQL) or some other database-query language known in the art. In the case of OLAP databases, one or more multi-item dimensional cubes or hyper cubes, including multidimensional data from which data is selected from or inserted into using a Multidimensional Expression (MDX) language, may be implemented. In the case of a database using tables and SQL, a database application such as, for example, MYSQL™, MICROSOFT SQL SERVER™, ORACLE 8I™, 10G™, or some other suitable database application may be used to manage the data. In this, the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. The tables or cubes made up of tables, in the case of, for example, ROLAP, are organized into an RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization or optimization algorithm known in the art.

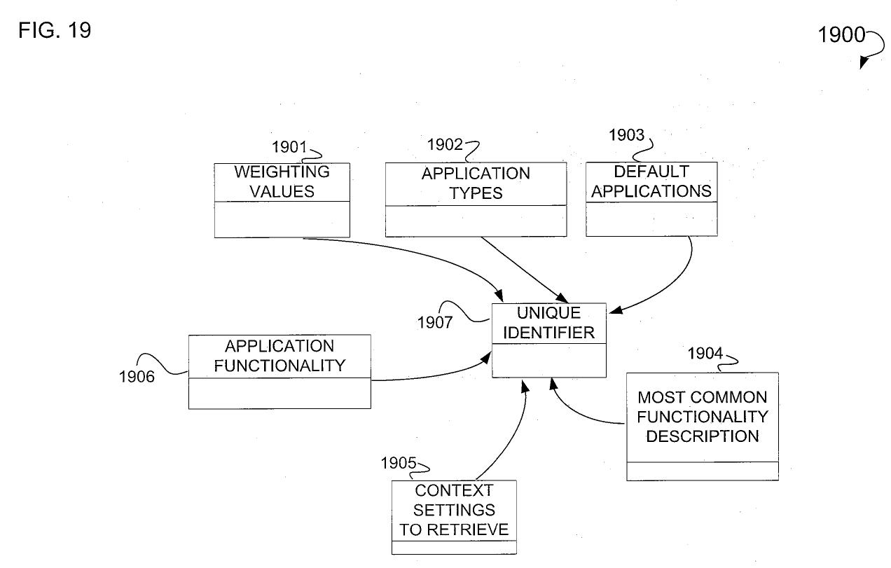

FIG. 19 is an example Relational Data Scheme (RDS) 1900. Shown is a table 1901 that includes weighting values. These weighting values may be stored as an integer, float, or double data type, and may be provided by a system administrator or other suitable individual to weight data included in the list of applications 1208, the session device information 1308, or the current context information 1609. A table 1902 is shown that includes application types. These application types may be stores as, for example, an eXtensible Markup Language (XML) data type, string data type, or some other suitable data type that identifies a particular type of application. Table 1903 is shown that includes default applications. These default applications may be stored as a Binary Large OBject (BLOB), or other suitable data type that maybe used by all devices participating in an environment, context, or session. These defaults may be stored for use as the most common functionality. Table 1904 includes a most common functionality description. Data stored into table 1904 may be formatted using an XML or some other suitable data type that may allow for the describing of the most common functionality associated with a device or devices. Table 1905 includes context settings. These context settings may be stored as an XML data type, and may reflect particular context information that is used to further define a session in which the device is participating. Table 1906 is shown that includes application functionality. This application functionality may be stored as a BLOB data type and may include functionality in the form of a software applications or components of software applications. A table 1907 is shown that includes unique identifier information, where this unique identifier's information is used to uniquely identify each of the entries in the tables 1901 through 1906. An integer data type may be used to store entries in the table 1907.

### Distributed Computing Components and Protocols

Some example embodiments may include remote procedure calls being used to implement one or more of the above-illustrated components across a distributed programming environment. For example, a logic level may reside on a first computer system that is located remotely from a second computer system including an interface level (e.g., a GUI). These first and second computer systems can be configured in a server-client, peer-to-peer, or some other configuration. The various levels can be written using the above-illustrated component design principles and can be written in the same programming language or in different programming languages. Various protocols may be implemented to enable these various levels and the components included therein to communicate regardless of the programming language used to write these components. For example, an operation written in C++ using Common Object Request Broker Architecture (CORBA) or Simple Object Access Protocol (SOAP) can communicate with another remote module written in JAVA™. Suitable protocols include SOAP, CORBA, and other protocols well-known in the art.

### A Computer System

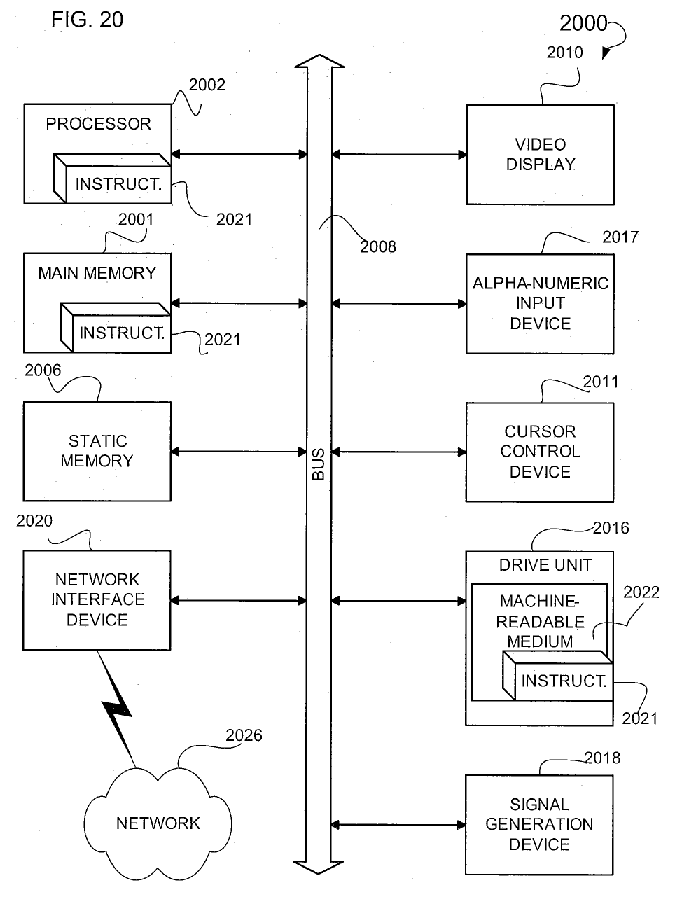

FIG. 20 shows a diagrammatic representation of a machine in the example form of a computer system 2000 that executes a set of instructions to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a Personal Computer (PC), a tablet PC, a Set-Top Box (STB), a PDA, a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 2000 includes a processor 2002 (e.g., a CPU, a Graphics Processing Unit (GPU) or both), a main memory 2001, and a static memory 2006, which communicate with each other via a bus 2008. The computer system 2000 may further include a video display unit 2010 (e.g., a Liquid Crystal Display (LCD) or a Cathode Ray Tube (CRT)). The computer system 2000 also includes an alphanumeric input device 2017 (e.g., a keyboard), a User Interface (UI) (e.g., GUI) cursor controller 2011 (e.g., a mouse), a drive unit 2016, a signal generation device 2018 (e.g., a speaker) and a network interface device (e.g., a transmitter) 2020.

The disk drive unit 2016 includes a machine-readable medium 2022 on which is stored one or more sets of instructions and data structures (e.g., software) 2021 embodying or used by any one or more of the methodologies or functions illustrated herein. The software instructions 2021 may also reside, completely or at least partially, within the main memory 2001 and/or within the processor 2002 during execution thereof by the computer system 2000, the main memory 2001 and the processor 2002 also constituting machine-readable media.

The instructions 2021 may further be transmitted or received over a network 2026 via the network interface device 2020 using any one of a number of well-known transfer protocols (e.g., Hyper Text Transfer Protocol (HTTP), Secure Hyper Text Transfer Protocol (HTTPS)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies illustrated herein. The term “machine-readable medium” shall accordingly be taken to include, but not be limited to, solid-state memories, optical and magnetic media, and carrier wave signals.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “Software as a Service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).).

What is claimed is:

1. A computer-implemented method comprising:
receiving selection input to select content to be presented by a first application. executing at a first device and a second application executing at a second device, the first and second devices participating in and in communication with one another over a common network-based session having a unique identifier;
selecting at least a first presentation option from a plurality of presentation options of the first and second applications for a presentation of the content, the selecting of the at least the first presentation option being based upon both a content type of the content and a presentation attribute, the presentation options including at least one of viewing, playing, listening, and executing;
detecting a mismatch in presentation functionalities of the applications executing on the first and second devices based on the first application having less functionality to process the content than functionality of the second application; and
retrieving a software module for the first device based, at least in part, on the mismatch as detected to bring parity to the presentation functionalities of the first and second applications executing on the first and second devices.

2. The computer-implemented method of claim 1, wherein the presentation attribute is an attribute of the selection input.

3. The computer-implemented method of claim 2, wherein the attribute of the selection input comprises a number of content items of the content to be presented by the device.

4. The computer-implemented method of claim 1, wherein the content type of the content is image content, and the first presentation option is a view option that is selected based on a single image being selected.

5. The computer-implemented method of claim 4, wherein the content type of the content is image content, and the first presentation option is a multi-item presentation option that is selected based on multiple images being selected.

6. The computer-implemented method of claim 5, wherein the multi-item presentation option is a slideshow presentation option.

7. The computer-implemented method of claim 5, wherein the multi-item presentation option is secondary selection option.

8. The computer-implemented method of claim 1, wherein the presentation attribute is a context attribute of a context within which the content is to be presented by the device.

9. The computer-implemented method of claim 8, wherein the context attribute is an environment attribute relating to an environment within which the content is to be presented by the device.

10. The computer-implemented method of claim 9, wherein the environment attribute identifies a number of users to which the content is to be presented by the device.

11. The computer-implemented method of claim 8, wherein the context attribute is an interaction attribute relating to an interaction within which the content is to be presented by the device.

12. The computer-implemented method of claim 11, wherein the interaction is the network-based session within which the presentation of the content is shared among a plurality of devices.

13. The computer-implemented method of claim 1, wherein the selection of the first presentation option comprises selection of a first application from among a plurality of applications for the presentation of the content,

14. The computer-implemented method of claim 1, wherein the selection of the first presentation option comprise a selection of a first presentation mode from among a plurality of presentation modes of a presentation application,

15. The computer-implemented method of claim 1, wherein the presentation attribute is an attribute of the device on which the content is to be presented.

16.-17. (canceled)

18. A computer system comprising:
a receiver to receive selection input to select content to be presented by a first application executing at a first device and a second application executing at a second device, the first and second devices participating in and in communication with one another over a common network-based communication session having a unique identifier;
a processor-implemented selection engine to select at least a first presentation option of the first and second applications from a plurality of presentation options for a presentation of the content, the selection of the at least the first presentation option being based upon both a content type of the select content and a presentation attribute, the presentation options including at least one of viewing, playing, listening, and executing;
a mismatch determination engine to detect a mismatch in presentation functionalities of the applications executing on the first and second devices based on the first application having less functionality to process the content than functionality of the second application; and
a retriever to retrieve a software module for the first device based at least in part on the mismatch as detected to bring parity to the presentation functionalities of the first and second applications executing on the first and second devices.

19. The computer system of claim 18, wherein the presentation attribute is an attribute of the selection input.

20. The computer system of claim 19, wherein the attribute of the selection input comprises a number of content items of the content to be presented by the device.

21. The computer system of claim 18, wherein the content type of the content is image content, and the first presentation option is a view option that is selected based on a single image being selected.

22. The computer system of claim 21, wherein the content type of the content is image content, and the first presentation option is a multi-item presentation option that is selected based on multiple images being selected.

23. The computer system of claim 22, wherein the multi-item presentation option is a slideshow presentation option.

24. The computer system of claim 22, wherein the multi-item presentation option is secondary selection option.

25. The computer system of claim 18, wherein the presentation attribute is a context attribute of a context within which the content is to be presented by the device.

26. The computer system of claim 25, wherein the context attribute is an environment attribute relating to an environment within which the content is to be presented by the device.

27. The computer system of claim 26, wherein the environmental attribute identifies a number of users to which the content is to be presented by the device,

28. The computer system of claim 25, wherein the context attribute is an interaction attribute relating to an interaction within which the content is to be presented by the device.

29. The computer system of claim 28, wherein the interaction is the network-based session within which the presentation of the content is shared among a plurality of devices.

30. The computer system of claim 18, wherein the selection of the first presentation option comprises selection of a first application from among a plurality of applications for the presentation of the content.

31. The computer system of claim 18, wherein the selection of the first presentation option comprise a selection of a first presentation mode from among a plurality of presentation modes of a presentation application.

32. The computer system of claim 18, wherein the presentation attribute is an attribute of the device on which the content is to be presented.

33.-35. (canceled)

36. A non-transitory machine-readable storage medium storing instructions, which when executed by a processor of one or more machines, cause the one or more machines to perform the following operations:
receive selection input to select content to be presented by a first application executing at a first device and a second application executing at a second device, the first and second devices participating in and in communication with one another over a common network-based communication session having a unique identifier; and
select at least a first presentation option from a plurality of presentation options of the first and second applications for a presentation of the content, the selecting of the at least the first presentation option being based upon both a content type of the select content and a presentation attribute, the presentation options including at least one of viewing, playing, listening, and executing;
detect a mismatch in presentation functionalities of the applications executing on the first and second devices based on the first application having less functionality to process the content than functionality of the second application; and
retrieve a software module for the first device based, at least in part, on the mismatch as detected to bring parity to the presentation functionalities of the first and second applications executing on the first and second devices.
